(19) United States
(12) Patent Application Publication
(10) Pub. No.: US 2012/0218652 A1
(43) Pub. Date: Aug. 30, 2012

(54) OPTICAL CONCENTRATOR SYSTEMS, DEVICES AND METHODS

(75) Inventors: Bradley R. Stone, Phoenix, AZ (US); Steven J. Stone, Urbana, IL (US); Kraig H.L. Hoekstra, Phoenix, AZ (US); Cameron M. Wyatt, Gilbert, AZ (US)

(73) Assignee: PEAK FLUX, INC., Phoenix, AZ (US)

(21) Appl. No.: 13/405,188

(22) Filed: Feb. 24, 2012

Related U.S. Application Data
(60) Provisional application No. 61/446,130, filed on Feb. 24, 2011.

(51) Int. Cl. G02B 5/10; G02B 7/182

(52) U.S. Cl. 359/853; 359/871

(57) ABSTRACT

A described embodiment provides a technology for concentrating or focusing electromagnetic energy to an arbitrary desired spatial distribution, utilizing a rotatable base, a plurality of mirrors mounted to the rotatable base, and an optical receiver that is moveable in an azimuth path relative to the plurality of mirrors. A described embodiment can comprise a driver for rotating the base and a adjusting linkage that connects the plurality of mirrors so that they track in a coordinated fashion. Another embodiment comprises an optical positioning assembly on which each mirror is mounted. An optical positioning assembly adjusts each mirror to the sun's altitude and the location for the optical receiver. This assembly is connected to the adjusting linkage so that a single driver can move all the mirrors if desired.

### CROSS-REFERENCE TO RELATED APPLICATIONS

This application is a non-provisional of and claims priority to U.S. Provisional No. 61/446,130, filed on Feb. 24, 2011 and entitled “OPTICAL CONCENTRATOR SYSTEMS AND DEVICES”, wherein such provisional application is hereby incorporated by reference in its entirety.

### FIELD OF INVENTION

The present invention relates to the field of optics and solar power generation.

### BACKGROUND

Concentrated solar power systems (CSP) are systems that use optical elements such as lenses or mirrors to concentrate a large area of intercepted sunlight, or solar thermal energy, onto a small area. Electrical power is produced when the concentrated light is converted to heat which drives a heat engine connected to an electrical power generator. The concentration of sunlight onto photovoltaic surfaces, similar to CSP, is known as concentrated photovoltaics (CPV).

Solar concentrators maximize the amount of sunlight that can be concentrated through the use of solar tracking. Solar tracking systems can track the sun about one or two axes. Tracking systems that move about a single axis are known as single axis tracking systems. Likewise, tracking systems that move about two axes are known as dual axis tracking systems.

Single axis tracking systems are typically used in non-concentrating photovoltaic, trough, or linear-Fresnel systems. When used in non-concentrating photovoltaic systems, the single axis tracking mechanism allows the photovoltaic panel to follow the motion of the sun from East to West; and this motion is commonly referred to as azimuthal or azimuth tracking. When used in concentrating trough or linear-Fresnel systems, the tracking system follows the rise of the sun to the zenith; and this motion is commonly referred to as zenithal or elevation tracking. In like manner, dual axis tracking systems also follow the azimuth motion of the sun and in addition, dual axis tracking systems follow the zenithal motion of the sun. Zenith motion represents the elevation of the sun above the horizon. For example, during the wintertime at Northern latitudes, the sun moves towards the South and is “lower” in the sky than it is during the summertime.

Other dual tracking concentrators can be categorized as either dish-based or tower-based concentrators. In dish-based systems, a parabolic dish is rotated so that the optical receiver is always in the focus of the dish and the dish is always perpendicular to the incoming sunlight. Thus, the area of the dish with respect to the sun is always the same. Dishes are limited in terms of size, however, as the structural strength and amount of material grow as the cube of the radius of the dish.

Tower-based systems typically comprise a central optical receiver placed on top of a tall tower and surrounded by a heliostat field of rotatable pedestal mounted heliostat mirrors. Each individual heliostat mirror tracks the sun so that the light from the sun is directed onto the optical receiver. Such systems require a complicated tracking system and driver for each individual mirror. In such systems, the azimuthal drive components for the individual heliostat mirrors can constitute a major portion of the cost of the system.

In addition, the expenses involved with solar generated power need to be lowered so that solar generated power is a viable alternative to power generated with conventional technologies. Therefore, a need exists to more efficiently harness the sun's energy by optimizing the dual tracking of the sun's motion and lowering the expenses of building and operating solar concentrators so that solar-generated power can be a viable alternative.

### SUMMARY

In accordance with various aspects of the disclosed embodiments, the sun's energy can be converted into electricity by optimizing the dual tracking of the sun's motion. Such optimization can be facilitated through movement of the optical receiver and/or movement of a positioning assembly coordinated with the sun's azimuth and elevation path. Because embodiments herein require less equipment, maintenance, and electricity to generate the same amount of electricity as current solar concentrators, multiple efficiencies can be realized to make a solar concentrator system more affordable. Disclosed embodiments can also generate a much higher peak electro-magnetic flux than a linear system or conventional power tower system.

In an embodiment, an optical positioning assembly can adjust an optical reflector or an optical receiver to the sun's altitude, azimuth angle, and/or the location for the optical receiver. This assembly can be connected to the adjusting linkage so that a single driver can move a plurality of optical reflectors or receivers if desired. In accordance with an embodiment, an optical positioning assembly can be pivotable positioning assembly, such as a pivotable parallelogram. Alternatively, a optical positioning assembly can comprise geared positioning assembly, a plurality of gears to achieve the same purpose.

In accordance with embodiments, an optical concentrator system comprises a rotatable base, a plurality of mirrors mounted to the rotatable base, and an optical receiver that is moveable in an azimuth path relative to the plurality of mirrors. An optical concentrator system can further comprise an optical positioning assembly. In an embodiment, an optical concentrator system can further comprise a driver for rotating the base and a adjusting linkage that connects the plurality of mirrors so that they track in a coordinated fashion. The adjusting linkage and the base act together in such a manner as to ensure that these mirrors all track to direct the light of the sun into or onto the solar receiver.

Because the “solar arm” of the linkage is constrained to motion in the plane of rotation of the sun with respect to the mirror, and because this plane is substantially parallel for all mirror elements, a single drive can be used to activate all mechanical linkages for the mirrors.

### BRIEF DESCRIPTION OF THE DRAWINGS

The accompanying drawings provide a further understanding of the invention and are incorporated in and constitute a part of this specification, illustrate embodiments of the invention and together with the description serve to explain the principles of the invention.

FIG. 1 illustrates an example configuration of an optical concentrator system comprising a base, a plurality of mirrors, and an optical receiver mounted on the base;

FIGS. 2(a) and 2(b) illustrate a front and rear view of an embodiment of a positioning assembly for an individual mirror;

FIG. 3 illustrates an exploded view of an embodiment of a positioning assembly for an individual mirror;

FIG. 4 illustrates a series of different views of an embodiment of an optical positioning assembly for an optical reflector or optical receiver;

FIG. 5 illustrates two positions of an optical reflector or an optical receiver by adjusting the elevation arm;

FIG. 6 illustrates embodiments of a plurality of positioning assemblies connected to an adjusting linkage;

FIG. 7 illustrates embodiments of a plurality of positioning assemblies in different positions due to movement of the adjusting linkage; and

FIG. 8 illustrates an assembled embodiment in two perspective views of the embodiment illustrated in FIG. 3.

### DETAILED DESCRIPTION

The following description is of various embodiments only, and is not intended to limit the scope, applicability or configuration of the present disclosure in any way. Rather, the following description is intended to provide a convenient illustration for implementing various embodiments including the best mode. As will become apparent, various changes can be made in the function and arrangement of the elements described in these embodiments, without departing from the scope of the appended claims. For example, the steps recited in any of the method or process descriptions can be executed in any order and are not necessarily limited to the order presented. Moreover, many of the manufacturing functions or steps can be outsourced to or performed by one or more third parties. Furthermore, any reference to singular includes plural embodiments, and any reference to more than one component or step can include a singular embodiment or step. Also, any reference to attached, fixed, connected or the like can include permanent, removable, temporary, partial, full and/or any other possible attachment option. As used herein, the terms “coupled,” “coupling,” or any other variation thereof, are intended to cover a physical connection, an electrical connection, a magnetic connection, an optical connection, a communicative connection, a functional connection, and/or any other connection.

For the sake of brevity, conventional techniques for mechanical system construction, management, operation, measurement, optimization, and/or control, as well as conventional techniques for mechanical power transfer, modulation, control, and/or use, may not be described in detail herein. Furthermore, the connecting lines shown in various figures contained herein are intended to represent exemplary functional relationships and/or physical couplings between various elements. It should be noted that many alternative or additional functional relationships or physical connections can be present in a solar concentrator or mirror positioning assembly as described herein.

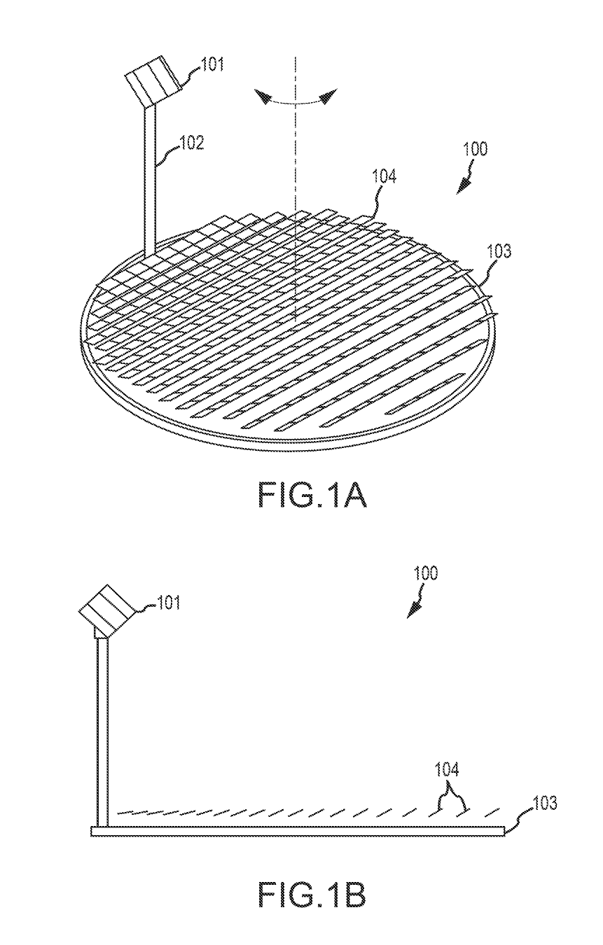

In accordance with an embodiment, with reference to FIG. 1, an optical concentrator system 100 comprises an optical receiver 101 that is moveable along a path relative to a plurality of mirrors 104. In a solar concentrator application, this path (“azimuth path”) would track the azimuth motion of the sun; i.e., during operation, the imaginary line between the approximate center of plurality of mirrors 104 and optical receiver 101 would be approximate the azimuth angle of the sun.

Mirrors 104 are configured to track the motion of optical receiver 101. In an embodiment, mounting mirrors 104 and optical receiver 101 on a rotatable base 103 can facilitate movement of optical receiver 101 and permits mirrors 104 to track the motion of optical receiver 101, which thereby also track the azimuth motion of the sun. Thus, mirrors also move along an azimuth path. While it is preferred, it is not required that optical receiver 101 be mounted to rotatable base 103. Optical receiver 101 can be mounted on its own locomotion system. Such system can comprise a rotatable ring that circumscribes the rotatable base. Other systems can simply be optical receiver 101 on a wheel, rail, or a track system that moves optical receiver 101 along an azimuth path.

Similarly, while it is preferred, it is not required that mirrors 104 be mounted on rotatable base 103. For example, plurality of mirrors 104 can be moveable on a series of arced or concentric tracks or concentric rings. However, any configuration which substantially maintains a fixed relative position between each mirror and optical receiver 101 while optical receiver 101 is in motion is contemplated. Because optical receiver 101 moves with rotatable base 103 and mirrors 104, each mirror can focus onto a smaller optical aperture than other concentrating.

Alternatively, maintaining a fixed relative position between each mirror and optical receiver 101 is not required. Each mirror can track optical receiver's 101 motion, and thereby the sun's azimuth motion, by rotating about the elevation angle as well as the azimuth angle. The positioning assembly described below can be utilized to track the azimuth angle, as well as the elevation angle or a mirror.

In an embodiment, rotatable base 103 can comprise any structure capable of supporting plurality of mirrors 104 which permits mirrors 104 to track the motion of optical receiver 101 which thereby also track the azimuth motion of the sun. One embodiment comprises a disk configured to rotate. The disk can comprise any structure of any shape wherein the areas of the top and bottom surfaces are much greater than the sum of the side(s), such that it may be described as thin. Other embodiments of a base can comprise a plurality of spokes emanating from a hub and configured to support at least one mirror on each spoke. Each spoke can be of varying or equal lengths.

Rotatable base 103 can be supported via a single pedestal about which it can spin; a track, rail, or gear system; a liquid, such as water, including salt water, oil, or any other fluid capable of supporting base 103; or combination thereof. The above listed features can also facilitate rotation of base 103. The rotational force can be applied about a specific point or axis of rotation, such as with the use of a pedestal, or it can be applied distant from the axis of rotation, such as with a track, rail, gear system. The axis of rotation may or may not be at the geometric center of the base.

If a fluid is contributing to the support of base 103, a natural or man-made liquid basin will be required. Base 103 will float on a pool of water or other fluid, thereby spreading the mechanical loads across the entire base, reducing bracing requirements and hence amount of bracing metal. The use of a floating mirror support structure causes the movement of optical receiver 101 or mirror array 104 to require a very low power motors for azimuth motion. In addition, only a very small number of motors (i.e. two per floating disk) are needed to operate.

Base 103 can comprise materials that provide sufficient strength to support mirrors 104 as well as optical receiver 101 if optical receiver 101 is also mounted to base 103. Such materials can include concrete, reinforced Styrofoam, metal foams, composites, reinforced plastics, or inflatable structural elements. An optical concentrator system can be constructed on either a small or large scale. For example, base 103 can span an area from about approximately 1 to 1 million square meters. In a preferred embodiment, base 103 can span an area of about approximately 80 to 5000 square meters.

Optical receiver 101 comprises any apparatus capable of absorbing electromagnetic radiation, such as a photovoltaic cell or solar receiver as used in a solar thermal power plant now known or hereinafter derived. Other examples of optical receiver 101 include a holding tank for heating a fluid, e.g. a solar water heater. The optical receiver 101 can also include photon enhanced thermionic emission (PETE) cells, photovoltaic plasma cells, or chemical processing cells that utilize high intensity solar radiation for energy conversion. The optical receiver 101 can also include chemical or material processing systems for changing the state or chemistry of matter. The optical receiver 101 can also include any thermal or optical storage system that stores heat or optical energy for later use. The optical receiver 101 can also constitute a radio frequency receiver for astronomy, communications, or other radio frequency process radiation

A mirror 104, also referred to as an optical reflector, comprises anything with a reflective surface capable of reflecting visible or non-visible electromagnetic radiation. A mirror 104 can be rectangular, circular, or any other symmetric or asymmetric shape. The surface contours of a mirror can comprise planar, spherical, parabolic, concave, or convex contours, combinations and iterations thereof, or any other surface contour whether regular or irregular, smooth or jagged. The surface texture is preferably smooth but can also be semi-smooth, semi-rough, or rough. A mirror can further comprise any material coated with a thin metal layer. A solar mirror can be constructed of glass, plastic, foam, concrete, composite, metal, dielectric, or any other solid material.

Mirrors 104 are positioned in such a way that the radiation from a distant source (i.e., solar energy from the sun) is focused onto optical receiver 101. The angle of mirrors 104, the relative position of mirrors 104 and optical receiver 101, and respective paths of each can be adjusted so that the spatial or angular distribution of the light can be adjusted to optimize light collection for any purpose. The mirrors' motion tracks or is coordinated with the motion of optical receiver 101 so that mirrors 104 reflect radiation onto optical receiver 101.

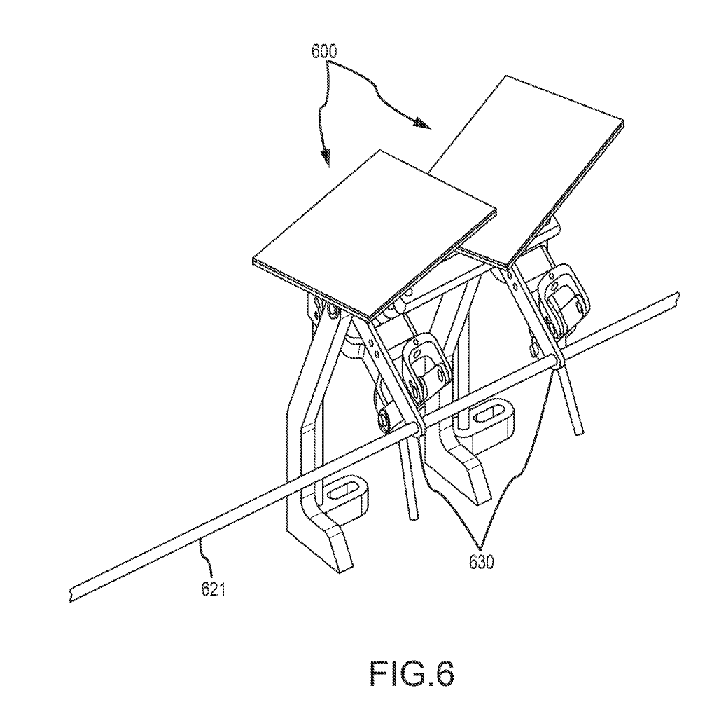

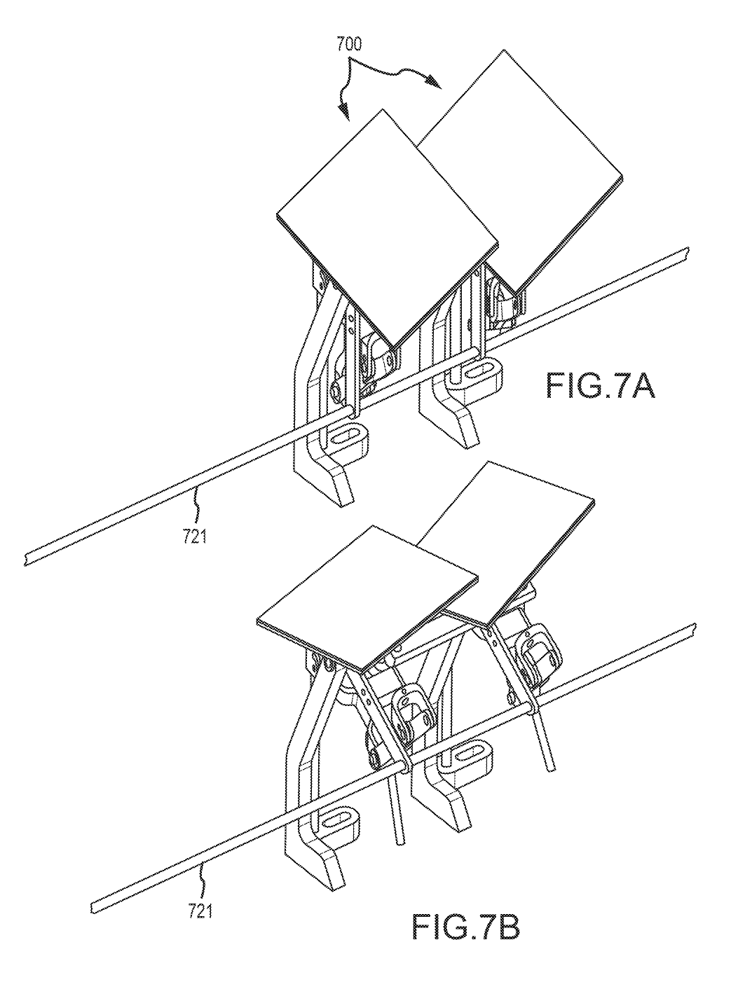

A adjusting linkage comprises a series of connectors which engage each optical positioning assembly on which a mirror is mounted so that mirrors can be adjusted in a coordinated fashion with a low number of drives, contemplating that only a single drive may be utilized to adjust the position of all the mirrors. In a rotatable base embodiment or the like, a adjusting linkage need only adjust for the elevation changes of the sun. The adjusting linkage and the rotatable base act together in such a manner as to ensure that these mirrors all track to direct the light of the sun into or onto the solar receiver. The adjusting linkage can connect all mirrors to a single adjustment mechanism, such as a driver. In accordance with an embodiment, with reference to FIG. 6, an adjusting linkage can comprise a drive shaft 621 to intersect and couple elevation arm 630 on at least two or a plurality of optical assembly 600. Thus, by moving the drive shaft 621 through space, elevation arms 630 are all moved together. FIG. 7 illustrates an embodiment comprising a drive shaft 721 in two different positions, and the corresponding change in mirror rotation for each individual mirror assembly 700.

As such, the solar concentrator can comprise any adjustment mechanism that engages the adjusting linkage to adjust plurality of mirror 104. An adjustment mechanism can be any mechanical or electromechanical system comprising a motor, driver, rack and pinion, planetary gear, worm gear, pneumatic, hydraulic, electro-restrictive component, pulley, cable, chain, sprocket, sheave, belt, turnbuckle, screw, wedge, or combinations and iterations thereof. An adjustment mechanism can be motorized or manually controlled. While a single adjustment mechanism is all that may be necessary, multiple mechanisms can be utilized so that sections, groups, or rows of mirrors can be adjusted separately from other sections, groups, or rows of mirrors.

In accordance with the embodiment, the solar concentrating system can comprise a rotating mechanism to rotate base 103, although it is contemplated that multiple rotating mechanisms can be used. A rotating mechanism can be any mechanical or electromechanical system comprising a motor, driver, rack and pinion, planetary gear, worm gear, pneumatic, hydraulic, electro-restrictive component, pulley, cable, chain, sprocket, sheave, belt, or combinations and iterations thereof. A rotating mechanism can be motorized or manually controlled. A single device can encompass both the adjustment mechanism and the rotating mechanism to execute both functions such that it is engaged to both the adjusting linkage and the rotatable base.

In an embodiment, the driver could be powered by a battery, fly-wheel, pressure vessel, photovoltaic cell, steam, power from power lines, or any other power source now known or hereinafter derived. Thus, the optical concentrator system can employ all variety of internal power supplies or mechanisms to connect to external power supplies.

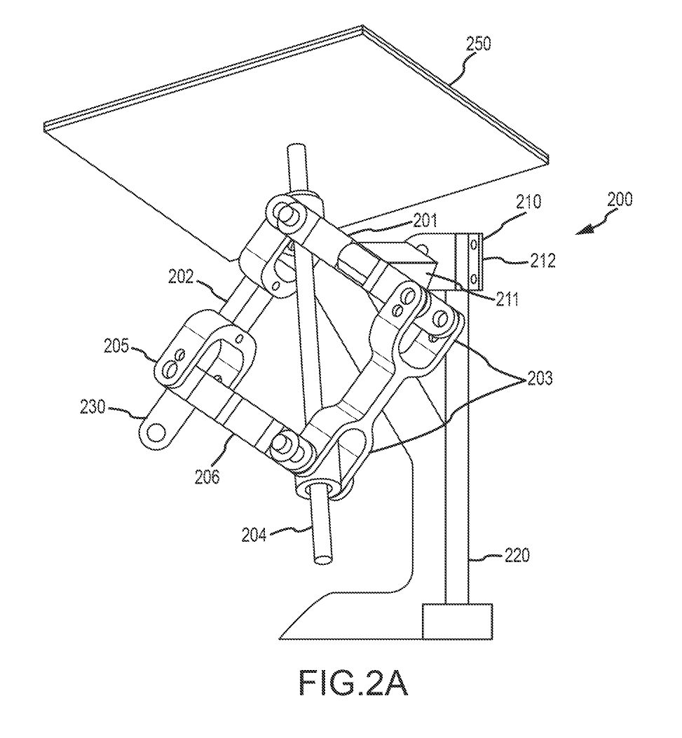

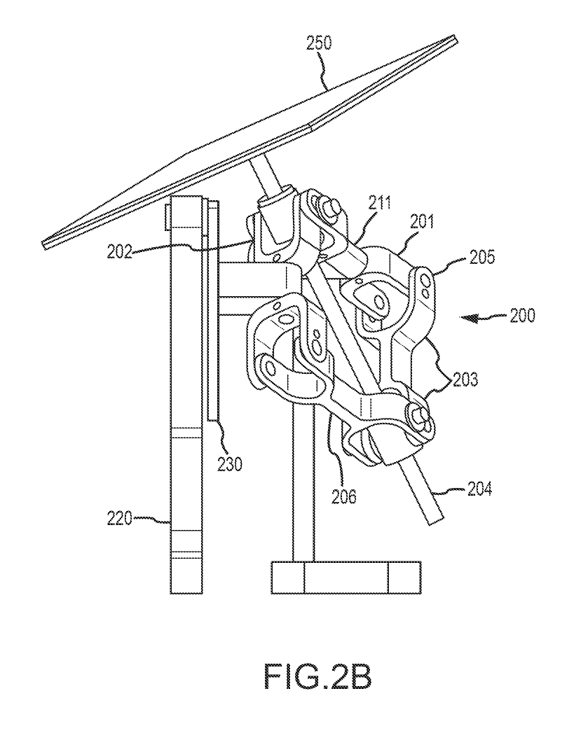

In accordance with an embodiment, with reference to FIGS. 2(a)-2(b), an optical positioning assembly 200 is used to position an optical reflector, such as a mirror 250. Alternatively, the assembly 200 can be used to position an optical receiver 250, such as a photovoltaic cell. The optical positioning assembly 200 positions mirror 250 such that the incident light will be reflected to a specified point on the optical receiver (not shown). In a solar concentrator, the factors relevant to adjust assembly 200 and position mirror 250 comprise the relative location of the optical receiver, the elevation of the sun, and the azimuth angle of the sun. Optical positioning assembly 200 can be configured to adjust mirror 250 accounting for changes in all three factors.

However, an optical concentrator comprising a rotational base or the like simplifies the process of positioning mirror 250. As previously described, the relative position of the mirror and optical receiver is constant. The sun's azimuth motion is accounted for through the rotation of the rotatable base to which mirror 250 is mounted. The rotatable base rotates and the optical tower moves such that imaginary line created by the center of the rotatable base and the optical tower has the same azimuth angle as the sun. Thus, the only varying factor is the elevation arm. In a rotation base embodiment or the like, optical positioning assembly 200 must be configured to account for the optical receiver as a constant and the sun's elevation which is subject to variation.

In an embodiment, optical positioning assembly 200 can comprise a pivoting linkage 205, such as a four-sided linkage. For example, optical positioning assembly can comprises a pivotable parallelogram 205, slidably connected to shaft 204. Shaft 204 is slidably connected to parallelogram 205 such that shaft 204 approximates a bisecting diagonal of parallelogram 205. In other words, shaft 204 is always positioned such that the longitudinal axis of shaft 204 approximately bisects the angles formed at a pair of opposite corners of parallelogram 205.

Pivotable linkage 205 can comprise four pivotably connected arms. As stated above, the arms can be in substantially the shape of a parallelogram. For purposes of explanation, two of these arms are referenced herein as solar arm 202 (or second side) and receiver arm 201 (or first side), and collectively as upper arms. Solar arm 202 is coupled to elevation arm 230 such that the centerline always intersects with the sun, preferably the approximate center of the sun, i.e. second spatial vector. Receiver arm 201 is adjustable so that its longitudinal axis intersects a desired point on the optical receiver, i.e., first spatial vector.

Aiming mechanism 210 facilitates the adjustment of receiver arm 201, holds it 201 in position once the adjustment is made, but still permits arm 201 to rotate about its longitudinal axis. In an embodiment, aiming mechanism can comprise an adjustable barrel 211 and barrel mount 212 to facilitate this receiver arm adjustment because barrel 211 is pivotably connected to barrel mount 212. Receiver arm 201 held in position by barrel 211 can be positioned accordingly by pivotally adjusting barrel 211 and fastening barrel 211 into its new position with the use of a fastener. A fastener comprises any mechanism that can fix the position of the barrel including a set screw, nut and bolt, glue, weld, clamp, detent, or the like. Barrel 211 and receiver arm 201 do not need to be repositioned once set unless the position of the optical receiver changes relative to mirror 250, which should not be the case during normal operation.

Solar arm 202 is coupled to elevation arm 230. Solar arm 202 is adjustable so that its longitudinal axis intersects a desired point on the optical emitter (not shown), e.g. sun. In a solar concentrator application, elevation arm 230 can move in a plane to adjust solar arm 202 as the elevation angle of the sun changes in the sky. Additionally, elevation arm 202 can rotate so that it adjusts solar arm 202 to track both the elevation angle and the azimuth angle. Because the sun's elevation angle and azimuth angle gradually change, the position of solar arm 202 can be adjusted gradually. Elevation arm 230 can make adjustments continuously or incrementally. In an embodiment, elevation arm 230 can be a rigid extension of the solar arm 202 connectable to adjusting linkage.

An adjusting linkage connected to a driver and can be used to move elevation arm 230 and thereby adjust the position of solar arm 202. While it is contemplated that each mirror can use its own individual driver consisting of a motor and a controller or the like, an can also be based on a shared driver the adjusts a plurality of optical positioning assemblies 200.

In accordance with an embodiment, the adjusting linkage, such as a drive shaft, can interconnect a plurality of optical positioning assemblies 200 so that the adjustment mechanism can be shared amongst multiple mirrors. In an embodiment, with reference to FIG. 6, an adjusting linkage can comprise driveshaft 621 to intersect elevation arm 630 on each individual mirror assembly 600. Thus, by moving drive shaft 621 through space, elevation arms 630 are all moved together. FIG. 7 illustrates an embodiment comprising drive shaft 721 in two different positions, and the corresponding change in mirror rotation for each individual mirror assembly 700.

In embodiments comprising a plurality of interconnected optical positioning assemblies, as illustrated in FIG. 6, a low number of drivers can be utilized to adjust the position of the mirrors, and it is contemplated that only a single driver can be utilized to adjust the plurality of mirrors or all mirrors in the system. A plurality of assemblies can comprise about approximately 2 to 5000 mirrors, preferably 200 to 700 mirrors. In an embodiment comprising a plurality of optical positioning assemblies, a first driver can be configured to make an adjustment to the plurality of optical positioning assemblies that tracks the sun's elevation angle and a second driver can be configured to make an adjustment to the plurality of optical positioning assemblies that tracks the sun's azimuth angle. An adjusting linkage can be coupled to both the first and second drivers, which in turn cab be coupled to the elevation arm.

Referring back to FIG. 2, once connected to a shared adjustment mechanism, elevation arm 230 can be rotated about an axis that is perpendicular to an imaginary line connecting the center of rotation of the disk to the sun but parallel to the plane of the mirror support structure. The rotation of elevation arm 230 can be thus constrained to rotation in elevation without any rotation in azimuth with respect to the disk surface. As elevation arm 230 is rotated about this axis of rotation, the entire assembly rotates about the upper arms.

Elevation arm 230 can rotate so that it adjusts solar arm 202 to track both the elevation angle and the azimuth angle of the sun. The rotation of elevation arm 230 can be thus free to rotate in elevation as well as in azimuth with respect to the base and/or the mirror. Thus, the linkage assembly will cause the light from the sun (or any other optical source) to be reflected to the direction of the receiver (or other target direction,) so long as the solar arm 202 is positioned to track the direction of the sun and the other arm 201 is positioned to track the direction of the receiver.

During operation, the centerlines of the upper arms adjust to maintain a parallel position with respect to corresponding points (a distant point on the sun and the desired aligned intersection on the tower.) Shaft 204 bisects the angle between these two centerlines. Mirror 250 can be attached to shaft 204 so that its optical axis (or surface normal in the case of a planar mirror) is collinear with the longitudinal axis of shaft 204. Thus, as one arm of this linkage 202 points towards the sun and the other arm 201 points towards the receiver, then light hitting mirror 250 will be reflected towards the receiver as desired.

Pivotable parallelogram comprises four arms 201, 202 forming approximately a parallelogram and pivotably connected at each vertex. In a preferred embodiment, arm 201, 202 comprises clevis 203 connected to each end of rod 206 with the width of one clevis being larger than the other end. An arm 201, 202 can also comprise a double clevis with no middle rod. Each arm 201, 202 can be of the same length or varying lengths so long as the distance between the pivot points is substantially equal. Receiver arm 201 is rotatably connected to barrel 211 so that receiver arm 201 can rotate about its longitudinal axis.

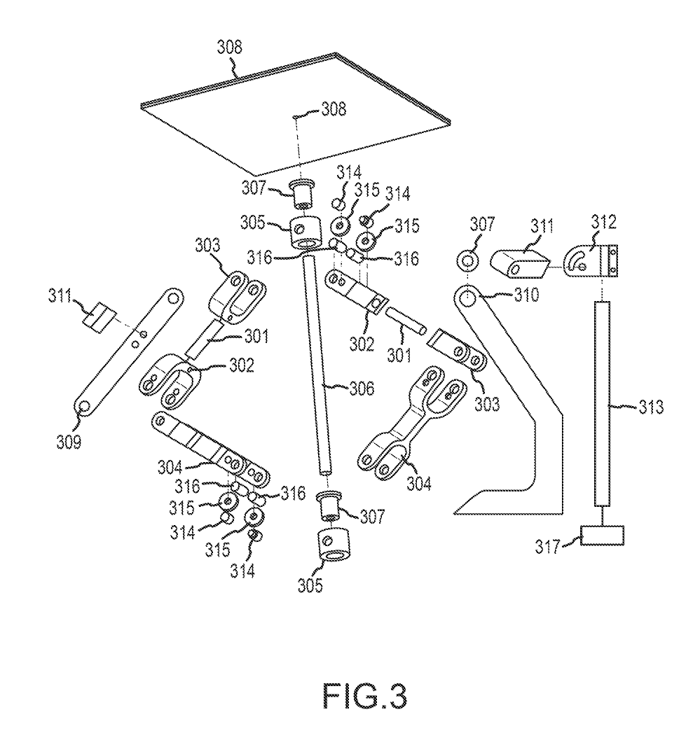

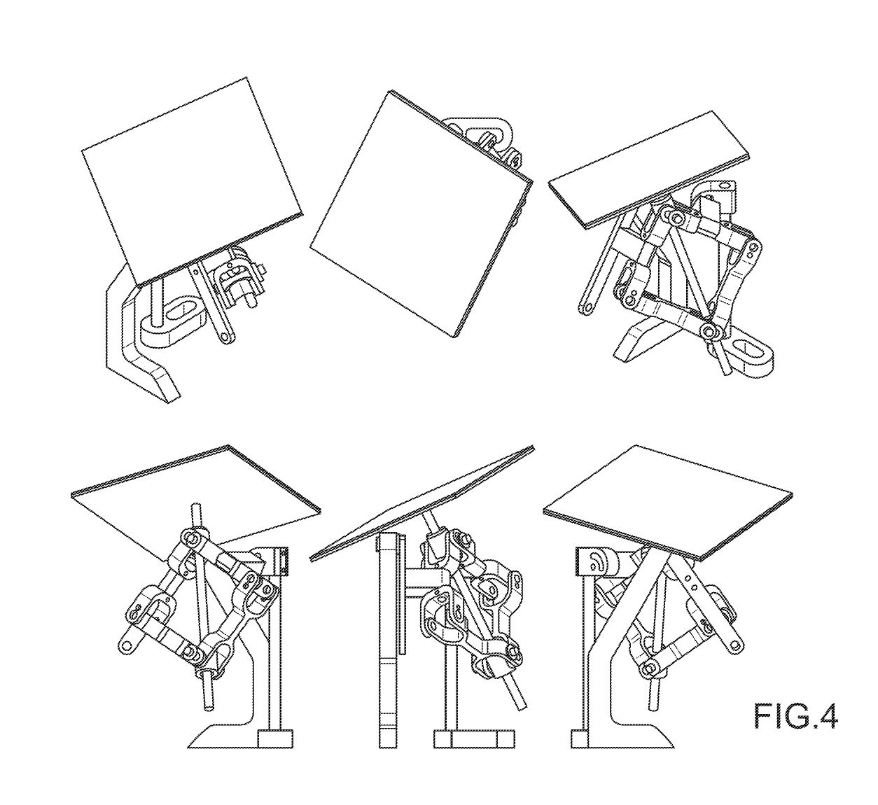

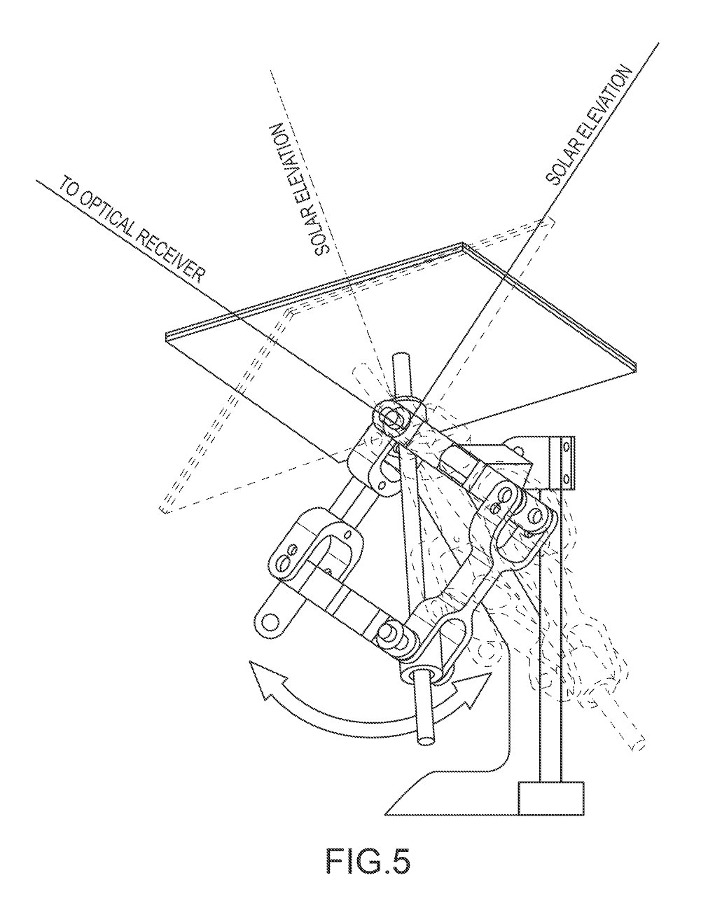

FIG. 3 illustrates an exploded view of an optical positioning assembly embodiment. The component of which can comprise a link shaft 301, first clevis 302, second clevis 303, dog bone-like shaft 304, triple point 305, shaft 306, bushing 307, mirror 308, elevation arm 309, bearing mount 310, elevation triple point 311, aimer new 312, all thread 313, 4-40 bolt 314, 4-40 washer 315, pin 316, and optics mount 317. Second clevis 303 is small than first clevis 302.

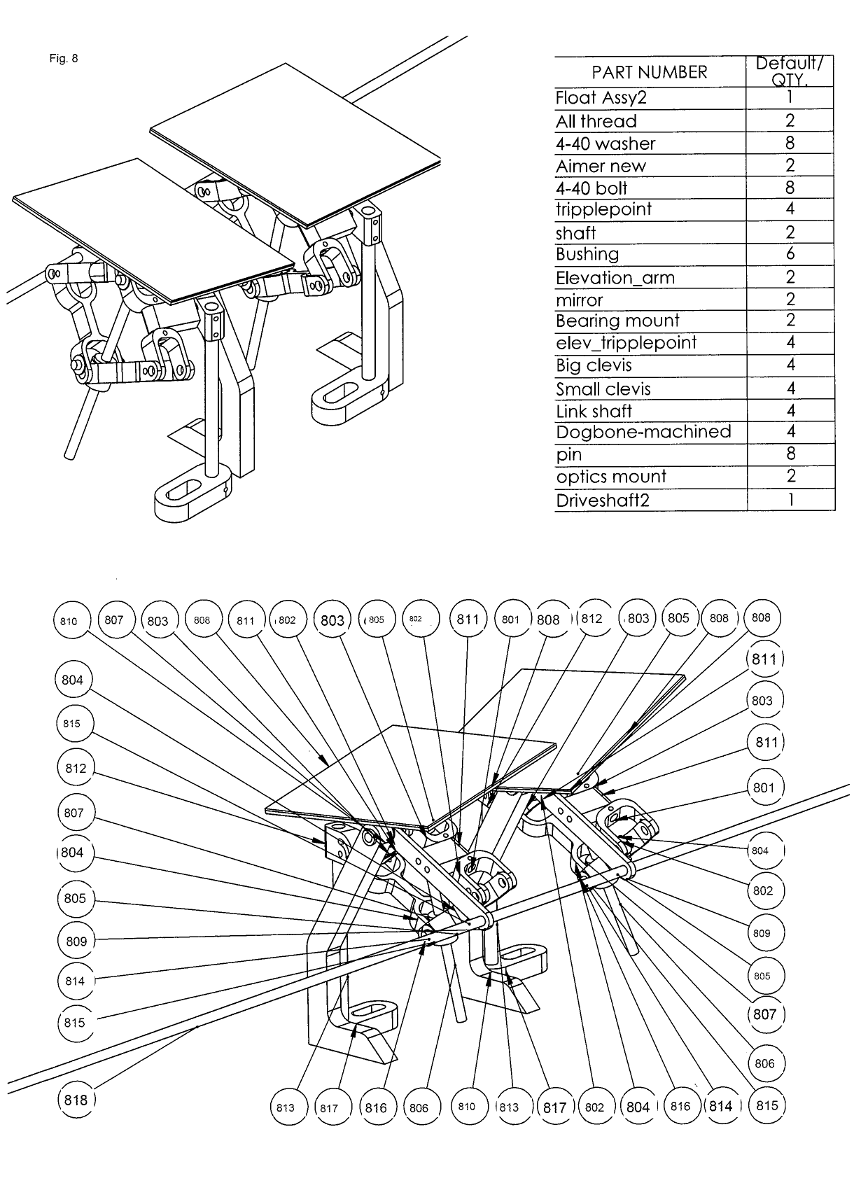

FIG. 8 illustrates an assembled view of the same embodiment of FIG. 3. The component of which can comprise a link shaft 801, first clevis 802, second clevis 803, dog bone-like shaft 804, triple point 805, shaft 806, bushing 807, mirror 808, elevation arm 809, bearing mount 810, elevation triple point 811, aimer new 812, all thread 813, 4-40 bolt 814, 4-40 washer 815, pin 816, optics mount 817, and driveshaft 818.

An alternative positioning assembly 205 can comprise a plurality of gears in order to bisect the two vectors mechanically. For example, the plurality of gears can comprise a 2:1 gear ratio to facilitate the mechanical calculation and position the mirror such that the vector normal to the mirrors surface bisects the incident angle and reflected angle of incident light.

In an embodiment, optical positioning assembly 200 can further comprise a support stem 220. Support stem is mountable to a rotatable base and is configured to withstand the weight of mirror 250 and assembly 200, and the weather variables encountered on site. In embodiments wherein assembly 200 is mounted upon a base in a liquid, as described herein, the support strength required to withstand weight and weather can be lessened.

In accordance with an embodiment, a method of concentrating or capturing electromagnetic radiation, such as solar radiation, comprises providing an optical positioning assembly, as described herein. A mirror or an optical receiver can be mounted to the shaft of the assembly, or in the case of multiple assemblies, on each shaft of the assemblies. A drive mechanism can be provided to adjust the angle of at least two mirrors up to all of the mirrors. The adjustments can be coordinated with the motion of the sun, coordinated track either or both of the sun's elevation angle and the azimuth angle. In order to adjust, a drive shaft can couple at least two pivotable parallelograms to the drive mechanism. The angle of the mirror is adjusted to direct solar radiation to an optical receiver.

In accordance with an embodiment, a method of concentrating or capturing electromagnetic radiation, such as solar radiation, comprises moving the mirrors along an arced path. The arced path can be different for each mirror, and depends on the location of the mirror in relation to the optical receiver. In a further embodiment, the optical receiver moves along an arced path also can be a different path then the path of each mirror.

The devices, systems, and methods as described above can have applications in a variety of areas in which directing, reflecting, or collecting light is desired such as solar power, optical imaging, and radio-astronomy. The scale and size of the systems and devices can vary depending on the application. Both large and small scale systems and devices are contemplated. The system could be scaled to generate electricity for a single household or be scaled and replicated to generate electricity for a public electricity supplier. The systems and devices could be modified for use inside an optical instrument. A system can be portable. For example, the system can be mounted onto a trailer or the top of a vehicle.

The foregoing disclosure is merely illustrative of the present invention and is not intended to be construed as limiting the invention. Although one or more embodiments of the present invention have been described, persons skilled in the art will readily appreciate that numerous modifications could be made without departing from the spirit and scope of the present invention. As such, it should be understood that all such modifications are intended to be included within the scope of the present invention.

We claim:

1. An optical positioning assembly comprising
a shaft;
a pivotable linkage slidably coupled to the shaft; and
a adjustable barrel which is spinnably coupled to a first side of the pivotable linkage.

2. The positioning assembly of claim 1, further comprises a mirror mounted to the shaft.

3. The positioning assembly of claim 2, further comprises an adjusting linkage coupled to an elevation arm, wherein a second side of the pivotable linkage, adjacent to the first side, is coupled to the elevation arm.

4. The positioning assembly of claim 3, further comprising a support stem coupled to the adjustable barrel.

5. The positioning assembly of claim 1, wherein the shaft approximately bisects the angle between a first spatial vector and second spatial vector;
wherein the first spatial vector is formed by the first side and the second spatial vector a second side of the pivotable linkage, adjacent to the first side;
wherein a longitudinal axis of the first side intersects a desired point on the optical receiver and a longitudinal axis of the second side intersects an emitter.

6. The positioning assembly of claim 5, wherein the pivotable linkage comprises a pivoting parallelogram.

7. The positioning assembly of claim 1, wherein elevation arm can be adjusted to track the elevation angle and the azimuth angle of the sun.

8. A system for concentrating or focusing electromagnetic radiation comprising
a plurality of optical positioning assemblies, each comprising a shaft and a pivotable linkage, wherein the pivotable linkage is slidably coupled to the shaft and wherein the shaft approximately bisects the angle between a first spatial vector and second spatial vector;
an adjusting linkage coupled to the plurality of optical positioning assemblies; and
a first driver coupled to the adjusting linkage.

9. The system as in claim 8, further comprising an optical receiver.

10. The system of claim 9, further comprising a plurality of mirrors, wherein a mirror of the plurality of mirrors is mounted onto the shaft of each optical positioning assembly.

11. The system of claim 10, wherein the optical receiver is moveable such that its movement is coordinated with the movement of the plurality of mirrors.

12. The system as in claim 10, further comprising a rotatable base upon which the optical positioning assembly are mounted.

13. The system as in claim 12, wherein the optical receiver is mounted onto the rotatable base.

14. The system as in claim 10, further comprising a second driver coupled to the adjusting mechanism, wherein the first driver is configured to make an adjustment to the plurality of optical positioning assemblies that tracks the sun's elevation angle and the second driver is configured to make an adjustment to the plurality of optical positioning assemblies that tracks the sun's azimuth angle.

15. A method of concentrating solar radiation comprising
providing a plurality of optical positioning assemblies comprising a shaft and a pivotable linkage slidably coupled to the shaft, wherein a mirror is mounted to the shaft of each assembly; and
adjusting a position of at least two mirrors with a single drive mechanism.

16. The method of concentrating solar radiation of claim 15, wherein a adjusting linkage couples at least two pivotable linkage to the drive mechanism.

17. The method of concentrating solar radiation of claim 16, further comprising moving all mirrors with a single drive mechanism.

18. The method of concentrating solar radiation of claim 17, directing solar radiation to an optical receiver.

19. The method of concentrating solar radiation of claim 18, moving the mirrors along an arced path.

20. The method of concentrating solar radiation of claim 18, moving an optical receiver along an arced path.
